(19) United States
(12) Patent Application Publication
(10) Pub. No.: US 2021/0081803 A1
(43) Pub. Date: Mar. 18, 2021

(54) On-Demand Knowledge Resource Management

(71) Applicant: International Business Machines Corporation, Armonk, NY (US)

(72) Inventors: Petar Ristoski, San Jose, CA (US); Anna Lisa Gentile, San Jose, CA (US); Daniel Gruhl, San Jose, CA (US); Linda Ha Kato, San Jose, CA (US); Chad Eric DeLuca, Morgan Hill, CA (US); Alfredo Alba, Morgan Hill, CA (US); Chris Kau, Mountain View, CA (US); Steven R. Welch, Gilroy, CA (US)

(73) Assignee: International Business Machines Corporation, Armonk, NY (US)

(21) Appl. No.: 16/573,413

(22) Filed: Sep. 17, 2019

(51) Int. Cl. G06N 3/08; G06K 9/62; G06N 20/00; G06N 5/02; G06F 17/24; G06F 17/27

(52) U.S. Cl. CPC G06N 3/088; G06K 9/6257; G06F 17/278; G06N 5/022; G06F 17/241; G06N 20/00

(57) ABSTRACT

Embodiments relate to a system, program product, and method for knowledge resource management. A first document is subjected to a first semantic annotation and one or more entities, relations, and textual annotations of interest are identified. A neural model is built with the first document and trained with the first document and one or more of the first semantic annotations. An un-annotated document is applied to the neural model, and one or more second semantic annotations are produced. The un-annotated document is enriched with the produced second semantic annotation(s) and is subjected to adjudication. The neural model is selectively amended responsive to the adjudication.

### BACKGROUND

The present embodiments relate to natural language processing (NLP) and information extraction across diverse input data. More specifically, the embodiments relate to extracting content from different types of formatted input data, and applying the extracted content to train one or more neural models to identify entity types, relations between entities, and textual annotations across a document set. Management of the knowledge extraction includes training the one or more models dictionary based on initial annotations, and re-training the one or more models based on adjudication of model generated annotations.

### SUMMARY

The embodiments include a system, computer program product, and method for knowledge resource management.

In one aspect, a system is provided with an artificial intelligence (AI) platform and one or more associated tools embedded therein for maintaining knowledge resources. A processing unit is operatively coupled to memory and is in communication with the AI platform and the embedded tools, including an annotation manager, a machine learning (ML) manager, and a document manager. The annotation manager functions to subject a first document to a first semantic annotation to identify one or more entities, relations, and textual annotations of interest. The ML manager builds a neural model with the first document and trains the neural model with the first document and one or more of the first semantic annotations. The document manager applies an un-annotated document, e.g. second document, to the neural model, and the neural model produces one or more second semantic annotations. The document manager enriches the un-annotated document with the produced second semantic annotation(s), thereby creating an enriched document, and subjects the enriched document to adjudication. In response to the adjudication, the ML manager selectively amends the neural model with one or more of the produced second semantic annotations.

In another aspect, a computer program device is provided for maintaining knowledge resources. The program code is executable by a processing unit to subject a first document to a first semantic annotation to identify one or more entities, relations, and textual annotations of interest. The program code builds a neural model with the first document and trains the neural model with the first document and one or more of the first semantic annotations. The program code applies an un-annotated document, e.g. second document, to the neural model, and the neural model produces one or more second semantic annotations. The second document is enriched with the produced second semantic annotation(s) and the enriched second document is subjected to adjudication. In response to the adjudication, the neural model is selectively amended with one or more of the produced second semantic annotations.

In yet another aspect, a method is provided for maintaining knowledge resources. A first document is subjected to a first semantic annotation and one or more entities, relations, and textual annotations of interest are identified. A neural model is built with the first document and the neural model is trained with the first document and one or more of the first semantic annotations. An un-annotated document, e.g. second document, is applied to the neural model, and one or more second semantic annotations are produced by the neural model. The second document is enriched with the produced second semantic annotation(s) and the enriched second document is subjected to adjudication. In response to the adjudication, the neural model is selectively amended with one or more of the produced second semantic annotations.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings reference herein forms a part of the specification. Features shown in the drawings are meant as illustrative of only some embodiments, and not of all embodiments, unless otherwise explicitly indicated.

FIG. 1 depicts a system diagram illustrating a system connected in a network environment that supports knowledge resource management.

FIG. 2 depicts a block diagram illustrating the AI platform tools, as shown and described in FIG. 1, and their associated application program interfaces.

FIG. 3 depicts a flow chart illustrating an initialization process, including building and training one or more neural models for a domain.

FIG. 4 depicts a flow chart illustrating an adjudication process, including leveraging the models built in the initialization process.

FIG. 5 depicts a flow chart illustrating document version comparison(s).

FIG. 6 depicts a block diagram illustrating an example of a computer system/server of a cloud based support system, to implement the system and processes described above with respect to FIGS. 1-5.

FIG. 7 depicts a block diagram illustrating a cloud computer environment.

FIG. 8 depicts a block diagram illustrating a set of functional abstraction model layers provided by the cloud computing environment.

### DETAILED DESCRIPTION

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

In the field of artificial intelligent systems, natural language processing systems (such as the IBM Watson® artificially intelligent computer system and other natural language interrogatory answering systems) process natural language based on knowledge acquired by the system. To process natural language, the system may be trained with data derived from a database or corpus of knowledge, but the resulting outcome can be incorrect or inaccurate for a variety of reasons.

Machine learning (ML), which is a subset of Artificial intelligence (AI), utilizes algorithms to learn from data and create foresights based on this data. AI refers to the intelligence when machines, based on information, are able to make decisions, which maximizes the chance of success in a given topic. ML employs one or more neural models to identify input patterns and contains algorithms that evolve over time. Neural models emulate the way the human nervous system operates. Basic units are referred to as neurons, which are typically organized into layers. The neural model works by simulating a large number of interconnected processing units that resemble abstract versions of neurons. There are typically three parts in a neural model, including an input layer, with units representing input fields, one or more hidden layers, and an output layer, with a unit or units representing target field(s). The units are connected with varying connection strengths or weights. Input data are presented in the first layer, and values are propagated from each neuron to every neuron in the next layers. A result is delivered from the output layer. Neural models are designed to emulate how the human brain works, so computers can be trained to support minimally defined abstractions and problems.

At the core of AI and associated reasoning lies the concept of similarity. The process of understanding natural language and objects requires reasoning from a relational perspective that can be challenging. Existing solutions for efficiently identifying objects and understanding natural language and processing content response is extremely difficult at a practical level.

It is recognized in the art that documents subject to processing may come in various formats, referred to herein as diverse input data. Examples of such formats include, but are not limited to portable document format (PDF), image PDF, web pages, word processed documents, spreadsheet documents, etc. PDF is a file format designed to present documents consistently across multiple devices and platforms. A PDF file can store a variety of data, including formatted text, vector graphics, and raster images. The PDF file contains page layout information, which defines the location of each item on the page, as well as the size and shape of the pages in the document. In one embodiment, this information is saved in a standard format, so that document looks the same regardless of the device or program used to open the document. The PDF format also supports metadata, such as the document title, author, subject, and keywords. However, it is understood that not all documents are formatted in PDF. Accordingly, the PDF is employed herein to illustrate an example of a document format.

As shown and described herein, a transparent and fluid solution is provided to perform data extraction directly on input documents, and to employ the extracted data to obtain and train one or more ML models, referred to herein as neural models. The neural models are directed to specific domains, e.g. a specific sphere of activity or knowledge. Examples of domains include, but are not limited to, financial industry, healthcare industry, etc. In one embodiment, a neural model trained for the financial industry domain may not be applicable to a neural model trained for the healthcare industry domain. Training a neural model on one or more documents or document sets employs annotated data. Annotation in ML is a process of labeling data across one or more data formats, e.g. text, image, audio, etc., to make the data recognizable for ML. In ML, annotation is the process of labeling data. As described in detail below, the annotations are employed to train the neural models to learn to recognize similar annotations when presented with new data. The training, e.g. building, and re-training process shown and described herein runs in two phases, including initialization and adjudication. Accordingly, as shown and described herein domain specific neural models are subject to training on annotated data, and re-training on knowledge extracted from a document or document set.

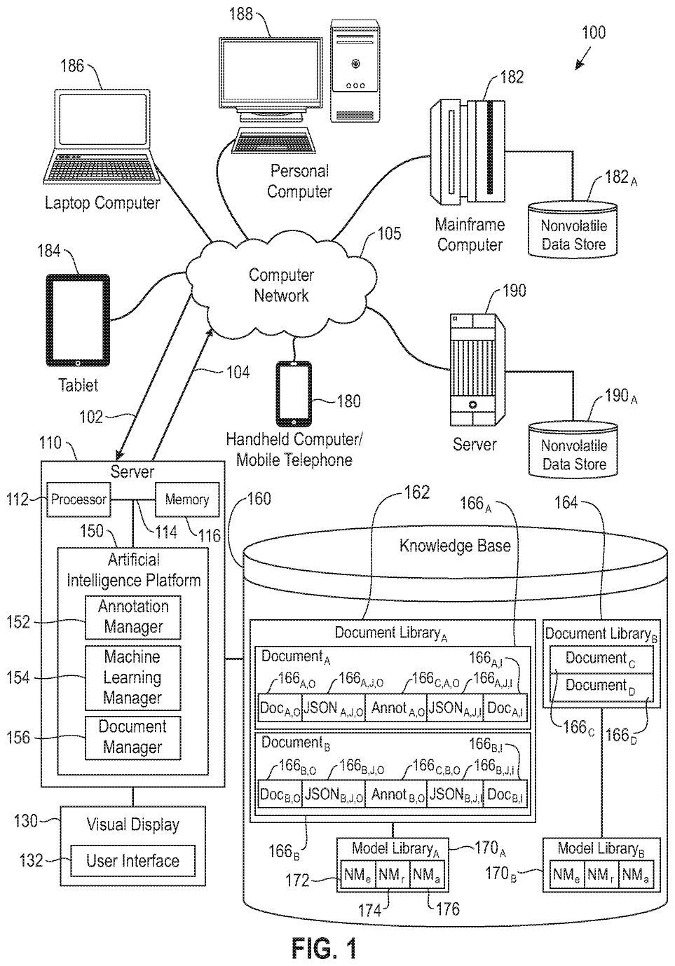

Referring to FIG. 1, a schematic diagram of a computer system (100) to support knowledge resource management is depicted. As shown, a server (110) is provided in communication with a plurality of computing devices (180), (182), (184), (186), (188), and (190) across a network connection (105). The server (110) is configured with a processing unit (112) in communication with memory (116) across a bus (114). The server (110) is shown with an artificial intelligence (AI) platform (150) with embedded tools to support and enable membership management of the dictionary over the network (105) from one or more of the computing devices (180), (182), (184), (186), (188), and (190). The server (110) is shown herein operatively coupled to a knowledge base (160). Each of the computing devices (180), (182), (184), (186), (188), and (190) communicate with each other and with other devices or components via one or more wired and/or wireless data communication links, where each communication link may comprise one or more of wires, routers, switches, transmitters, receivers, or the like. In addition, each of the computing devices (180)-(190) is operatively coupled to the knowledge base (160) across the network (105). Other embodiments of the server (110) may be used with components, systems, sub-systems, and/or devices other than those that are depicted herein.

The AI platform (150) is shown herein configured with tools to manage and facilitate application of cognitive computing with respect to knowledge resources, and more specifically to support membership and membership management of the dictionary. As shown, the knowledge base (160) is operatively coupled to the AI platform (150) and is configured with a plurality of libraries of documents, including library_{A} (162) and library_{B} (164). Although only two libraries are shown herein, the quantity should not be considered limiting. In one embodiment, and as shown herein, each library is operatively coupled to a corresponding textual corpus. For example, library_{A} (162) is operatively coupled to a first corpus, e.g. corpus_{A} (not shown), and library_{B} (164) is operatively coupled to a second corpus, e.g. corpus_{B} (not shown). In one embodiment, the library (162) or (164) may be operatively coupled to two or more corpi. Each library is populated with a plurality of documents. As shown herein, library_{A} (162) is populated with documents, including document_{A} (166_{A}) and document_{B} (166_{B}), and library_{B} (164) is populated with documents, including document_{C} (166_{C}) and document_{D} (166_{D}). The quantity of documents in each library is for descriptive purposes and should not be considered limiting.

The tools that comprise the AI platform (150) include an annotation manager (152), a machine learning (ML) manager (154), and a document manager (156) to manage and maintain knowledge resources. The annotation manager (152) functions to subject one or more documents in the knowledge base (160) to annotation, with the annotation identifying one or more entities, relations and textual annotations of interest within the one or more documents. Prior to subjecting the one or more documents to annotation, the annotation manager (152) converts an input format of the document into a structured object notation format, which in one embodiment is a structured object notation, e.g. javascript object notation (JSON) format. Prior to processing and annotating the documents in the library, each document is shown populated in the library in its original format. By way of example, document_{A} (166_{A}) is shown in its original format (166_{A,0}) prior to any document processing. Before the document is subject to annotation, the document is shown converted to the JSON format, e.g. JSON_{A,J,0} (166_{A,J,0}). Similarly, document_{B} (166_{B}) is shown in its original format (166_{B,0}) prior to any document processing. Accordingly, before the documents are subject to annotation, each document is shown converted to the JSON format, e.g. JSON_{A,0} (166_{A,J,0}) and JSON_{B,0} (168_{B,J,0}).

The document conversion maintains and retains all necessary data and metadata of the document. In one embodiment, the data and metadata are represented as input content to a corresponding neural model, as discussed in detail below. The format conversion maintains the document data in an independent format, thus enabling processing of any type of document. In the JSON format, all content, including structural content and metadata information, is retained to produce the exact same document file when needed. For example, an original document in PDF format is converted to the JSON format, and may later be produced or re-produced from the JSON format to the PDF format. In one embodiment, the JSON format preserves each token in the document with the information for a bounding box of the token, the style, and the token identifier. As shown herein by way of example, document_{A} (166_{A}) has a corresponding JSON format shown as JSON_{A,J,0} (166_{A,J,0}) and corresponding annotations, annotation_{A,0} (166_{C,A,0}), and document_{B} (166_{B}) has a corresponding JSON format shown as JSON_{B,J,0} (166_{B,J,0}) and corresponding annotations, annotation_{B,0} (166_{C,B,0}). Accordingly, prior to annotation of the document(s), the annotation manager (152) converts the document and corresponding document content, e.g. input content, to a structured object notation.

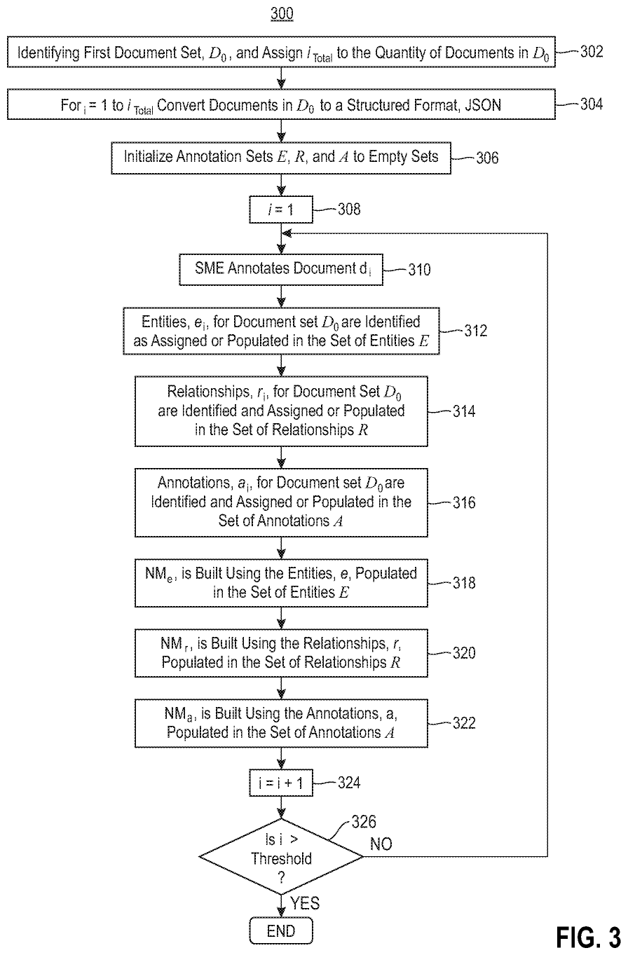

The ML manager (154) is shown herein operatively coupled to the annotation manager (152). The ML manager (154) functions to build and train, and in one embodiment re-train, one or more neural models (NMs). As shown and described in FIG. 3, the documents in the library, e.g. library_{A} (162), are subject to an initial annotation or annotation process by a subject matter expert (SME) to manually annotate the document(s). In one embodiment, the SME manually annotates a few entities of each type, which may then be used to facilitate and enable application of annotation by a corresponding neural model. The ML manager (154) builds and trains a neural model or a set of neural models with the initial annotations. As shown herein, library_{A} (162), also referred to herein as a document library, has a corresponding model library_{A} (170_{A}), and library_{B} (164) has a corresponding model library_{B} (170_{B}). The ML manager (154) populates the built neural models into a corresponding model library. Each model library is shown herein populated with a plurality of neural models. In one embodiment, a set of neural models are built and trained by the ML manager (154) for each library. As shown herein, model library_{A} (170_{A}) is shown with an entity model, NMₑ, (172), and relation model, NMᵣ (174), and a textual annotation model, NMₐ, (176). Although only three models are shown in the model library_{A} (170_{A}), this quantity is for illustrative purposes and should not be considered limiting. Accordingly, the ML manager (154) leverages the initial annotations to build one or more entity NMs, one or more relation NMs, and one of more textual annotation NMs.

The document manager (156) is shown operatively coupled to the ML manager (154) and the annotation manager (152). The document manager (156) is configured to leverage documents with respect to the neural models. As shown and described herein, the SME creates initial document annotations to build the neural models. An unannotated document, such as document_{A} (166_{A}) may be applied by the document manager (156) in a structured object notation, JSON_{A,J,0} (166_{A,J,0}) to build neural models, such as NMₑ, (172), relation model, NMᵣ (174), and a textual annotation model, NMₐ, (176). In one embodiment, the annotation manager (152) creates the structured object notation of each document subject to annotation, whether manual or machine annotation. Output from the NMs is in the form of annotations. More specifically, the NMs create machine generated annotations of the previously unannotated document, e.g. annotation_{A,0} (166_{C,A,0}). The document manager (156) enriches the annotation document by subjecting the annotated document to adjudication. In one embodiment, adjudication or an adjudication process employs one or more SMEs to review the machine generated annotations and to selectively accept or reject the machine generated annotations. The document manager (156) communicates annotation changes from the adjudication to the ML manager (154). More specifically, the ML manager (154) applies the communicated annotation changes to corresponding NMs, which effectively amends or selectively amends the NMs in receipt of the annotation changes. Accordingly, the NMs are subject to selective amendment following the adjudication process.

Documents, either individually or in combination, may be subject to amendment. The document manager (156) is configured to detect changes or amendments made to documents populated in the libraries of the knowledge base (160). Similarly, the document manager (156) is configured to detect an amendment or changes to the document annotations, which in one embodiment may take place in the document adjudication or adjudication process. Examples of annotation amendments include amendment of an entity annotation and amendment of a textual relation. The detected annotation amendments are communicated to the ML manager (154), which applies the detected annotation amendments to the corresponding model library to re-train the corresponding NMs with the annotation amendments. Accordingly, the document manager (156) and the ML manager (154) function to re-train, and effectively update, the corresponding NMs with annotation or document amendments.

The document manager (156) is configured to direct management of the documents through annotation, adjudication, and format conversion. The document manager (156) is responsible for conversion of document to the JSON format. As shown in the knowledge base (160), after annotation, a JSON format of the document with the annotations is stored in the library, e.g. JSON_{A,J,1} (166_{A,J,1}). In one embodiment, the document manager (156) identifies content and positional changes between an un-annotated version of the document and an annotated, e.g. enriched, document version. In one embodiment, the content and positional change identification may be via comparison of annotations, e.g. JSON_{A,J,0} (166_{A,J,0}), with JSON format, JSON_{A,J,1} (166_{A,J,1}) of the document. The document manager (156) adds annotations to the JSON representation of the document, shown herein as JSON_{A,J,1} (166_{A,J,1}), and stored in the library (162). After each annotation or set of annotations, the annotated document is converted to the original document format with the annotations, e.g. document_{A,1} (166_{A,1}), which can then be presented to the SME with the annotations for adjudication. The produced annotations are referred to herein as semantic annotations, and enrich the initial document without altering its layout. Examples of semantic annotations include, but are not limited to entity, relation, and salient sentence annotations. The document manager (156) adds semantic layers on top of the original document, in which each layer contains information for a specific semantic annotation. In one embodiment, the annotations or annotation layers may be toggled ON and OFF at will. Similarly, in one embodiment, for annotations that implement entity resolution, recognized entities are linkable and refer to corresponding external sources. As shown herein, a visual display (130) is operatively coupled to the server (110). A user interface (UI) (132) is provided on the visual display (130). The document manager (156) utilizes the UI (132) to enable document annotation and adjudication, as well as the document and document annotation presentation. Accordingly, the document manager (156) facilitates document processing and presentation.

It is understood in the art that the documents in the original format may be text based documents, or in one embodiment may be image based or contain images therein. The document manager (156) uses optical character recognition (OCR) to convert images into machine-encoded text, which may then be converted to the JSON format for annotation and adjudication.

As shown, the NMs create machine generated document annotations based on an initial set of SME applied annotations, or in one embodiment SME generated annotations subsequent to the annotation adjudication. The adjudication conducted by the SME controls annotation membership, also referred to herein as dictionary membership, in the form of selectively removing machine generated annotations from a corresponding dictionary. Accordingly, the adjudication of proposed candidate dictionary instances, e.g. machine generated annotations, includes selective removal from the dictionary or selective entry in the dictionary. Accordingly, dictionary membership is managed with respect to the contextual evaluation of the identified instances.

The various computing devices (180), (182), (184), (186), (188), and (190) in communication with the network (105) may include access points to the knowledge base (160) and the corresponding libraries and NMs. The AI platform (150) functions to manage dictionary membership of annotations of the libraries and corresponding NMs in support of the annotations, and application of documents to the NMs for machine generated annotations. It is understood that the NMs corresponding to a specific library are synchronized with the library both prior and subsequent to adjudication, so that application of the NMs to library documents may return applicable and appropriate document annotations. The ML manager (154) is responsible for training and re-training the NMs to synchronize the NMs with a current state of annotations.

The network (105) may include local network connections and remote connections in various embodiments, such that the AI platform (150) may operate in environments of any size, including local and global, e.g. the Internet. The AI platform (150) serves as a front-end system that can make available a variety of knowledge extracted from or represented in documents, network accessible sources and/or structured data sources. In this manner, some processes populate the AI platform (150), with the AI platform (150) also including input interfaces to receive requests and respond accordingly.

As shown, each library (162) and (164) may be in the form of one or more logically grouped documents or files. The knowledge base (160) may include structured and unstructured documents, including but not limited to any file, text, article, or source of data (e.g. scholarly articles, dictionary, definitions, encyclopedia references, and the like) for use by the AI platform (150). Content users may access the AI platform (150) via a network connection or an internet connection to the network (105). The UI (132) is accessible by the operatively coupled visual display (130) for annotation presentation for documents and document content in the knowledge base (160) corpus, or in one embodiment, any electronic data source operatively coupled to the server (110) across the network (105).

The AI platform (150) is shown herein with several tools to support dictionary membership and application. The tools, including the annotation manager (152), the ML manager (154), and the document manager (156), either individually or collectively function as either a software tool or a hardware tool.

In some illustrative embodiments, server (110) may be the IBM Watson® system available from International Business Machines Corporation of Armonk, N.Y., which is augmented with the mechanisms of the illustrative embodiments described hereafter. The IBM Watson® system may support the tools (152)-(156) to support knowledge resource management, including document annotation and adjudication as described herein. The tools (152)-(156), also referred to herein as AI tools, are shown as being embodied in or integrated within the AI platform (150) of the server (110). The AI tools may be implemented in a separate computing system (e.g., 190) that is connected across network (105) to the server (110). Wherever embodied, the AI tools function to support and enable a knowledge resource manager with respect to annotation and adjudication.

Types of information handling systems that can utilize the AI platform (150) range from small handheld devices, such as handheld computer/mobile telephone (180) to large mainframe systems, such as mainframe computer (182). Examples of handheld computer (180) include personal digital assistants (PDAs), personal entertainment devices, such as MP4 players, portable televisions, and compact disc players. Other examples of information handling systems include pen, or tablet computer (184), laptop, or notebook computer (186), personal computer system (188), and server (190). As shown, the various information handling systems can be networked together using computer network (105). Types of computer network (105) that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores (e.g., server (190) utilizes nonvolatile data store (190_{A}), and mainframe computer (182) utilizes nonvolatile data store (182_{A}). The nonvolatile data store (182_{A}) can be a component that is external to the various information handling systems or can be internal to one of the information handling systems.

The information handling system employed to support the AI platform (150) may take many forms, some of which are shown in FIG. 1. For example, AI platform may take the form of a desktop, server, portable, laptop, notebook, or other form factor computer or data processing system. In addition, the information handling system to support the AI platform (150) may take other form factors such as a personal digital assistant (PDA), a gaming device, ATM machine, a portable telephone device, a communication device or other devices that include a processor and memory. In addition, the information handling system need not necessarily embody the north bridge/south bridge controller architecture, as it will be appreciated that other architectures may also be employed.

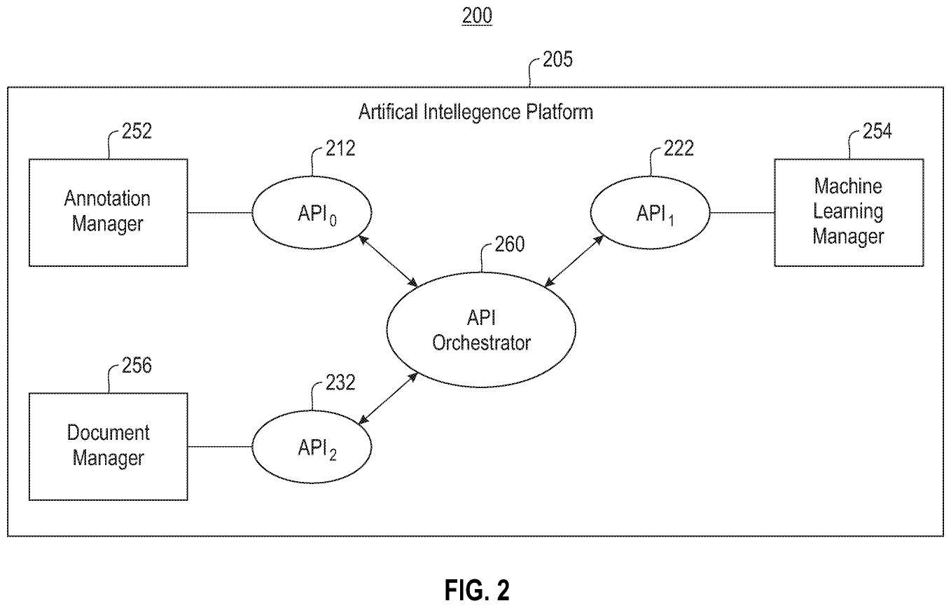

An Application Program Interface (API) is understood in the art as a software intermediary between two or more applications. With respect to the AI platform (150) shown and described in FIG. 1, one or more APIs may be utilized to support one or more of the tools (152)-(156) and their associated functionality. Referring to FIG. 2, a block diagram (200) is provided illustrating the tools (152)-(156) and their associated APIs. As shown, a plurality of tools are embedded within the AI platform (205), with the tools including the annotation manager (252) associated with API₀ (212), the ML manager (254) associated with API₁ (222), and the document manager (256) associated with API₂ (232). Each of the APIs may be implemented in one or more languages and interface specifications. API₀ (212) provides functional support to convert documents to the JSON format and to manage document annotation; API₁ (222) provides functional support to train and re-train one or more NMs with the semantic annotations; and API₂ (232) provides functional support to apply documents to the NMs for machine generated annotation, and to enrich documents with the semantic annotations. As shown, each of the APIs (212), (222), and (232) are operatively coupled to an API orchestrator (260), otherwise known as an orchestration layer, which is understood in the art to function as an abstraction layer to transparently thread together the separate APIs. In one embodiment, the functionality of the separate APIs may be joined or combined. As such, the configuration of the APIs shown herein should not be considered limiting. Accordingly, as shown herein, the functionality of the tools may be embodied or supported by their respective APIs.

Referring to FIG. 3, a flow chart (300) is provided to illustrate the initialization process, including building and training one or more neural models for a domain. As shown, a collection of documents, D₀, also referred to herein as a first document set, is identified and the quantity of documents in the first document set is assigned to the variable i_{Total} (302). Prior to processing the collection of documents, D₀, each of the documents in the document set D₀, is converted to a structured format (304), with the conversion including all necessary data and metadata to the represented input content. In one embodiment, the structured format is a javascript object notation, JSON. The use of the structured format, e.g. JSON, provides independence of the input data format. Each document is transformed to a structured format representation model, thus enabling processing of any type of document. Three sets of annotations for the collection are subject to initialization to empty sets (306), including a set of entities, E, a set of relationships, R, and a set of annotations, A. Accordingly, prior to subjecting the documents to annotation or an annotation process, the documents are converted to a structured format and corresponding annotation sets are initialized.

Each of the documents in the document set D₀ are subject to annotation or an annotation process. As shown herein, the document counting variable, i, is initialized (308), and a subject matter expert (SME) starts annotating the documents, dᵢ, in the document set, D₀, (310). The annotation process includes marking the entities, relations, and textual annotations of interest. More specifically, the annotation process identifies at least three elements within the document, dᵢ, with the elements including entities, relationships, and annotations within each document. The process of employing the SME is also referred to as human-in-the-loop (HumL). The entities, eᵢ for document set D₀ are identified and assigned or populated in the set of entities E (312), mathematically represented as E={e₀, e₁, e₂, . . . eᵢ}. Similarly, the set of relationships, rᵢ, for document set D₀ are identified and assigned or populated in the set of relationships R (314), mathematically represented as R={r₀, r₁, r₂, . . . rᵢ}, and the set of annotations, for document set D₀ are identified and assigned or populated in the set of annotations A (316), mathematically represented as A={a₀, a₁, a₂, . . . a₁}. Accordingly, populated sets E, R, and A initially contain SME marked and identified data.

Following step (316), or in one embodiment once a sufficient or minimal quantity of data is populated in the annotations sets E, R, and A, an ensemble of machine learning models, referred to herein individually as neural models (NMs), is built for each type of semantic annotation. As shown, an entity NM, NMₑ, is built using the entities, e, populated in the set of entities E (318), a relationship NM, NMᵣ, is built using the relationships, r, populated in the set of relationships R (320), and an annotation NM, NMₐ, is built using the annotations, a, populated in the set of annotations A (322). In one embodiment, the SME annotations are referred to herein as seed annotations and represent an initial set of annotations. In one embodiment, NMₑ is Named Entity Recognition (NER) neural model, and NMᵣ is a Relation Extraction (RE) neural model. The use of NER and RE models are for illustrative purposes, and in one embodiment, different neural models may be employed or substituted in place of these models. The NER model is a long-short term memory-convolutional neural network-conditional random field (LSTM-CNN-CRF) combination. The NER model generates entity candidates that are likely to express a relation. The RE model learns one relation at a time and assesses if the candidates actually express a relation. The NM models built at steps (318), (320), and (322) are models for the domain to which the document set D₀ is assigned. In one embodiment, a separate set of NM models are built for separately defined or identified domains. Accordingly, the initialization process is conducted over a set of documents in the domain and builds a set of NM models populated with data in the annotation sets E, R, and A for the defined or identified domain.

Following step (322), the document counting variable, i, is incremented (324). In one embodiment, each of the documents or a set quantity of documents in the document set is subject to initial annotations by the SME. Similarly, in one embodiment, a threshold of annotations is employed to establish the initial NM building. For purposes of description, the threshold for initial annotations is described as relating to a set quantity of documents in the document set. Following step (324), it is determined if the threshold quantity of documents for the document set have been annotated (326). A positive response concludes the initial document set annotation, and a negative response is followed by a return to step (310). Accordingly, one or more documents in the document set are subject to an initial annotation to build the corresponding neural models.

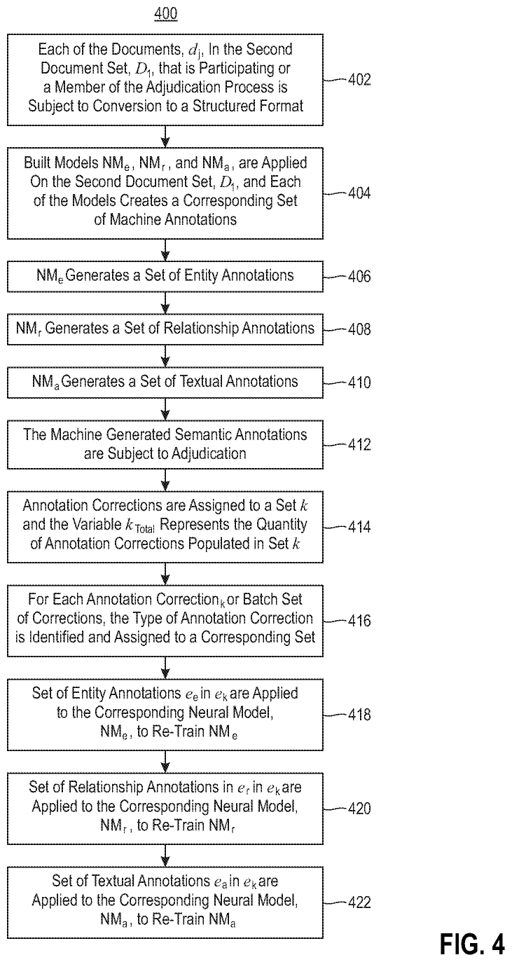

Referring to FIG. 4, a flow chart (400) is provided to illustrate the adjudication process, including leveraging the models built in the initialization process. As shown and described herein, the adjudication process is applied on documents in the first document set, D₀, that were not employed in the initialization process, or on a second set of document, D₁, that were not employed in the initialization process. For descriptive purposes, the adjudication process is shown conducted on the second document set, D₁, and the variable j_{Total} represents a quantity of documents in the second document set. Similar to the initialization process, each of the documents, d₁, in the second document set, D₁, that is participating or a member of the adjudication process is subject to conversion to a structured format (402). The conversion includes all necessary data and metadata to represented content in the documents dⱼ. In one embodiment, the structured format is a javascript object notation, JSON. The built models NMₑ, NMᵣ, and NMₐ, are applied on the second document set, D₁, and each of the models creates a corresponding set of machine annotations (404). In one embodiment, a domain learning assistant (DLA) is employed at step (404) to proposed new candidate entities as annotations. One example of an expansion engine is referred to as Explore and Exploit which operates in two phases, including the Explore phase to identify instances in an input text corpus which are similar to existing entries, where the similarity is based on term vectors from one or more of the NMs, and the Exploit phase which constructs complex multi-term phrases based on instances populated into the NM(s). Similarly, in one embodiment, the DLA employs another expansion engine referred to herein as Glimpse, which generates patterns of words that occur on either side of seed terms and scans the second document set for other words that match those patterns. As shown herein, regardless of the specific DLA and corresponding engine, NMₑ generates a set of entity annotations (406), NMᵣ generates a set of relationship annotations (408), and NMₐ generates a set of textual annotations (410). Accordingly, sets of machine generated semantic annotations are created and populated for the documents in the second document set.

Following step (410), the machine generated semantic annotations are subject to adjudication by the SME (412). More specifically, the SME is provided an opportunity to correct mistakes in the machine generated semantic annotations, and in one embodiment to identify missing semantic annotation, e.g. annotations that the neural model should have identified, hereinafter referred to collectively as annotation corrections. In one embodiment, a batch size is set for annotation corrections. The annotation corrections are assigned to a set k and the variable k_{Total} represents the quantity of annotation corrections populated in set k (414). In one embodiment, the adjudication is done directly in the document, and all collected information is transferred to the system. For each annotation correctionₖ or batch set of corrections, wherein the batch size is adjustable, the type of annotation correction is identified, e.g. entity, relationship, or textual annotation, and assigned to a corresponding set (416), with the set eₑ representing a set of entity corrections, the set eᵣ representing a set of relationship corrections, and the set eₐ representing a set of textual annotation corrections. The set of entity annotations eₑ in eₖ are applied to the corresponding neural model, NMₑ, to re-train NMₑ (418). Similarly, the set of relationship annotations in eᵣ in eₖ are applied to the corresponding neural model, NMᵣ, to re-train NMᵣ (420), and the set of textual annotations eₐ in eₖ are applied to the corresponding neural model, NMₐ, to re-train NMₐ (422). Once a new annotation or a set of new annotations is applied to the corresponding neural model, the neural model is re-trained and able to identify the new item, being an entity, relation, or textual annotation. New semantic annotations can be added at any time, and as new items are added to the NMs, the NMs are re-trained and able to identify the new item, being entity, or textual annotation. Accordingly, the adjudication process is directed at re-training one or more of the neural models with correction of one or more machine generated annotations.

The aspect of re-training a model, whether based on a correction of one or more machine generated annotations or based on new items, enhances the robustness of the corresponding model, which in one embodiment yields precision to future annotations. The SME influences types of semantic annotations that are going to be identified. Since the adjudication process utilizes or re-utilizes the knowledge of the SME, an acceptable level of accuracy performance can be attained.

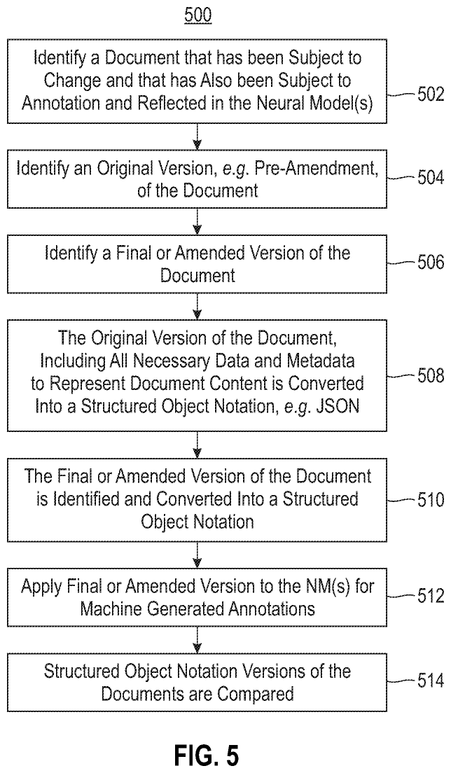

Referring to FIG. 5, a flow chart (500) is provided to illustrate comparing document versions. It is understood in the art that documents may be subject to change. At the same time, it is understood that not all documents are subject to change. A document that has been subject to change and that has also been subject to annotation and reflected in the neural model(s) is identified (502). Both an original version, e.g. pre-amendment, of the document is identified (504), and a final or amended version of the document is identified (506). The original version of the document, also referred to herein as the first document, is converted into a structured object notation, e.g. JSON, (508), including all necessary data and metadata to represent document content. The original version of the document is subject to annotation to create the NM(s). See FIG. 3 for further details. In addition, the identified final or amended version of the document, also referred to herein as a second document, is converted into a structured object notation (510) and applied to the NM(s) for machine generated annotations, and in one embodiment adjudication of the generated annotations (512). The structured object notation of the original document and the amended or final version of the document are compared to identify all content and positions changed between the document versions (514), e.g. the structured object notation versions of the documents are compared. The comparison at step (514) identifies information changes, addition, deletions, and content relocations. In one embodiment, the comparison is performed when a new version of an existing document is identified or created. Accordingly, the comparison shown and described herein is directed at utilizing the structured object notation versions of the original document and the amended document to identify document changes, including but not limited to, information changes, additions, deletions, and relocations.

It is understood that subjecting the amended document version to the NM(s) may generate new or additional document annotations. The comparison at step (514) may be expanded to create an overlay of the document annotations to the original document or to the amended version of the document. As shown herein, the expansion converts the amended document version to its original format, e.g. pre-structure object notation, and overlays identified semantic annotations to the un-annotated amended document in the original format, or the original document in the original format. In one embodiment, a user interface (UI) is provided as a platform to facilitate the document versions, annotations, and comparison. For example, a panel may be selected within the UI to see annotation details, and a selected word or phrase in the document would be presented on a corresponding visual display or window with an annotation and annotation details. Accordingly, the structured object notation is leveraged to identify content and positional details between documents or document versions, as well as employed to overlay annotations to a select document version.

As shown and described in FIG. 5, annotations are added to the structured object representation of the document. In one embodiment, the document pre-annotation is in PDF format. After each annotation, the PDF file is re-created and presented with the annotations. The produced annotations enrich the initial document, without altering its layout and potentially obscuring context needed to understand the text therein. To realize aspects of obscuring, semantic layers are added on top of the original document, where each layer contains information for a specific semantic annotation. In one embodiment, the semantic annotations can be toggled ON and OFF, at will. Similarly, in one embodiment, recognized entities are linkable and refer to external sources.

It is understood in the art that dictionary membership management may have some objective characteristics, and also some subjective characteristics. For example, in one embodiment, the method and system supports adjudication in the form of interaction of a human-in-the loop (HumL) to control direction of the dictionary membership, such as accepting or rejecting machine generated annotations. In one embodiment, the HumL controls semantic drift of the dictionary membership.

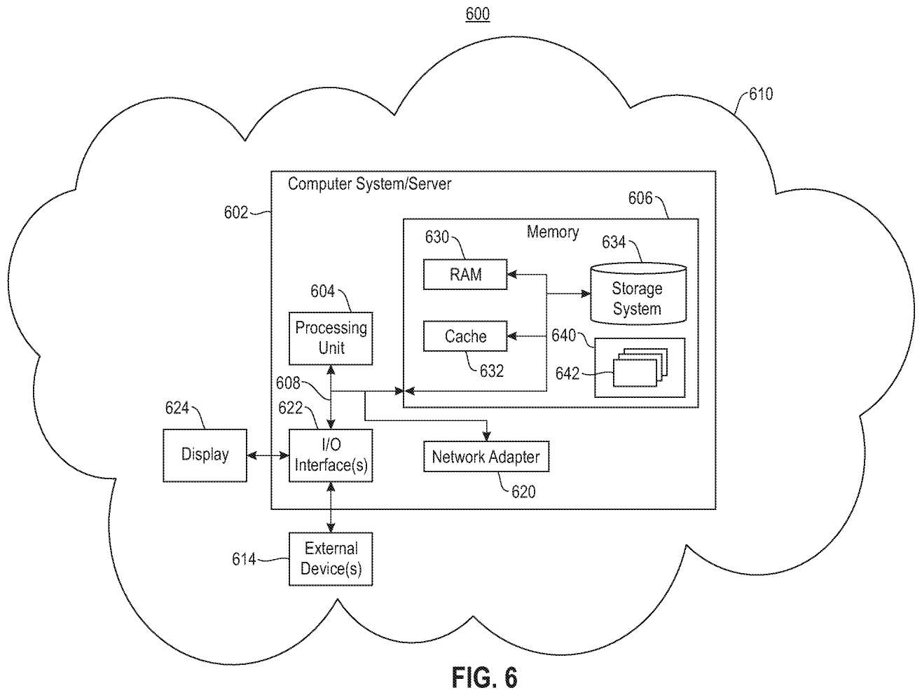

In a technical scenario, the dictionary that has been subject to seed word membership management may be applied against an un-annotated document to identify contextually related data. Aspects of the dictionary expansion and application as shown in FIG. 1-5, employs one or more functional tools, as shown and described in FIG. 1. Aspects of the functional tools (152)-(156) and their associated functionality may be embodied in a computer system/server in a single location, or in one embodiment, may be configured in a cloud based system sharing computing resources. With references to FIG. 6, a block diagram (600) is provided illustrating an example of a computer system/server (602), hereinafter referred to as a host (602) in a cloud computing environment (610), to implement the processes described above with respect to FIGS. 1-5. Host (602) is operational with numerous other general purpose or special purpose computing system environments or configurations. Examples of well-known computing systems, environments, and/or configurations that may be suitable for use with host (602) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

Host (602) may be described in the general context of computer system-executable instructions, such as program modules, being executed by a computer system. Generally, program modules may include routines, programs, objects, components, logic, data structures, and so on that perform particular tasks or implement particular abstract data types. Host (602) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, host (602) is shown in the form of a general-purpose computing device. The components of host (602) may include, but are not limited to, one or more processors or processing units (604), e.g. hardware processors, a system memory (606), and a bus (608) that couples various system components including system memory (606) to processor (604). Bus (608) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (602) typically includes a variety of computer system readable media. Such media may be any available media that is accessible by host (602) and it includes both volatile and non-volatile media, removable and non-removable media.

Memory (606) can include computer system readable media in the form of volatile memory, such as random access memory (RAM) (630) and/or cache memory (632). By way of example only, storage system (634) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (608) by one or more data media interfaces.

Program/utility (640), having a set (at least one) of program modules (642), may be stored in memory (606) by way of example, and not limitation, as well as an operating system, one or more application programs, other program modules, and program data. Each of the operating systems, one or more application programs, other program modules, and program data or some combination thereof, may include an implementation of a networking environment. Program modules (642) generally carry out the functions and/or methodologies of embodiments to iteratively manager seed word membership of one or more domain-specific dictionaries, and apply the managed dictionary to an unexplored corpus to identify matching data within the corpus to the seed word instances of the dictionary. For example, the set of program modules (642) may include the tools (152)-(156) as described in FIG. 1.

Host (602) may also communicate with one or more external devices (614), such as a keyboard, a pointing device, etc.; a display (624); one or more devices that enable a user to interact with host (602); and/or any devices (e.g., network card, modem, etc.) that enable host (602) to communicate with one or more other computing devices. Such communication can occur via Input/Output (I/O) interface(s) (622). Still yet, host (602) can communicate with one or more networks such as a local area network (LAN), a general wide area network (WAN), and/or a public network (e.g., the Internet) via network adapter (620). As depicted, network adapter (620) communicates with the other components of host (602) via bus (608). In one embodiment, a plurality of nodes of a distributed file system (not shown) is in communication with the host (602) via the I/O interface (622) or via the network adapter (620). It should be understood that although not shown, other hardware and/or software components could be used in conjunction with host (602). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (606), including RAM (630), cache (632), and storage system (634), such as a removable storage drive and a hard disk installed in a hard disk drive.

Computer programs (also called computer control logic) are stored in memory (606). Computer programs may also be received via a communication interface, such as network adapter (620). Such computer programs, when run, enable the computer system to perform the features of the present embodiments as discussed herein. In particular, the computer programs, when run, enable the processing unit (604) to perform the features of the computer system. Accordingly, such computer programs represent controllers of the computer system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the embodiments.

In one embodiment, host (602) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

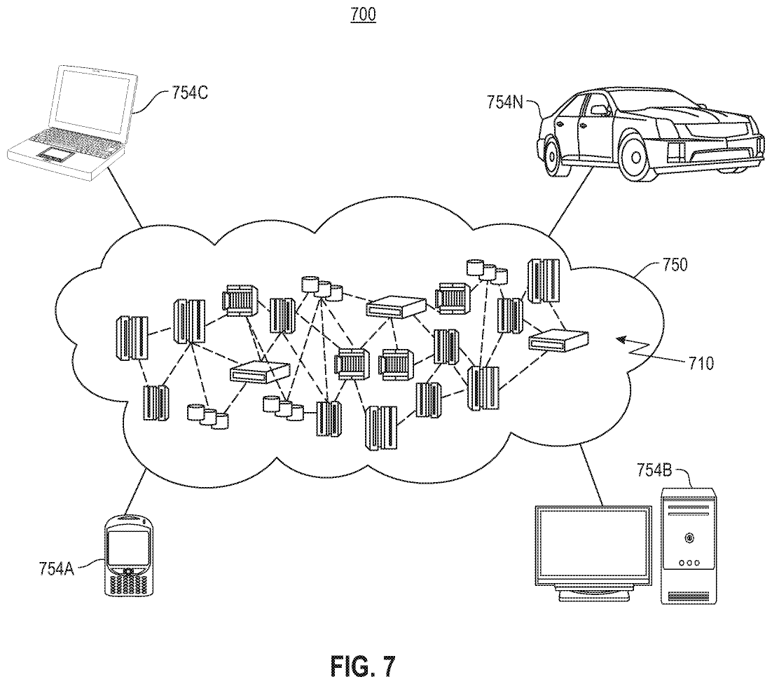

Referring now to FIG. 7, an illustrative cloud computing network (700). As shown, cloud computing network (700) includes a cloud computing environment (750) having one or more cloud computing nodes (710) with which local computing devices used by cloud consumers may communicate. Examples of these local computing devices include, but are not limited to, personal digital assistant (PDA) or cellular telephone (754A), desktop computer (754B), laptop computer (754C), and/or automobile computer system (754N). Individual nodes within nodes (710) may further communicate with one another. They may be grouped (not shown) physically or virtually, in one or more networks, such as Private, Community, Public, or Hybrid clouds as described hereinabove, or a combination thereof. This allows cloud computing environment (700) to offer infrastructure, platforms and/or software as services for which a cloud consumer does not need to maintain resources on a local computing device. It is understood that the types of computing devices (754A-N) shown in FIG. 7 are intended to be illustrative only and that the cloud computing environment (750) can communicate with any type of computerized device over any type of network and/or network addressable connection (e.g., using a web browser).

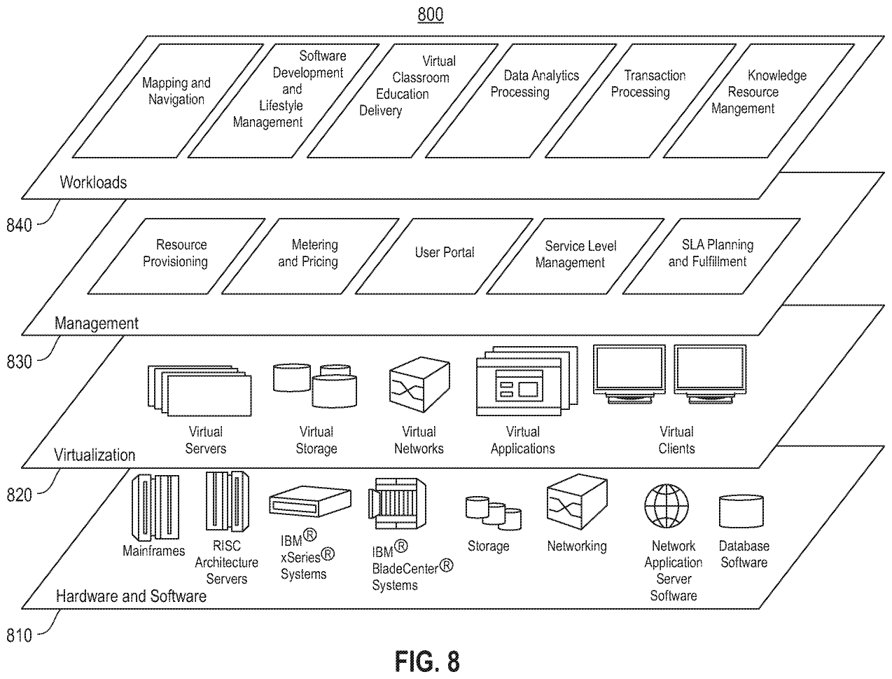

Referring now to FIG. 8, a set of functional abstraction layers (800) provided by the cloud computing network of FIG. 7 is shown. It should be understood in advance that the components, layers, and functions shown in FIG. 8 are intended to be illustrative only, and the embodiments are not limited thereto. As depicted, the following layers and corresponding functions are provided: hardware and software layer (810), virtualization layer (820), management layer (830), and workload layer (840).

The hardware and software layer (810) includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer (820) provides an abstraction layer from which the following examples of virtual entities may be provided: virtual servers; virtual storage; virtual networks, including virtual private networks; virtual applications and operating systems; and virtual clients.

In one example, management layer (830) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (840) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and knowledge resource management.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product is operative to improve the functionality and operation of an artificial intelligence platform to expand the dictionary and apply the expanded dictionary and dictionary instances to identify matching corpus data.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. Accordingly, the scope of protection of the embodiments is limited only by the following claims and their equivalents.

What is claimed is:

1. A computer system comprising:
a processing unit operatively coupled to memory;
an artificial intelligence (AI) platform in communication with the processing unit, the AI platform to maintain knowledge resources, including:
an annotation manager to subject a first document to a first semantic annotation, including the annotation manager to identify one or more entities, relations, and textual annotations of interest;
a machine learning (ML) manager operatively coupled to the annotation manager, the ML manager to build a neural model and train the neural model with the first document, including the ML manager to train the neural model with one or more of the first semantic annotations;
a document manager to apply a second un-annotated document to the build neural model, including the neural model to produce one or more second semantic annotations;
the document manager to enrich the second document with the produced one or more second semantic annotations, and subject the enriched second document to adjudication; and
responsive to the adjudication, the ML manager to selectively amend the neural model with one or more of the produced second semantic annotations.

2. The computer system of claim 1, further comprising the document manager to detect an amendment of one or more of the produced second semantic annotations, including identify a component of the amendment selected from the group consisting of: an entity and a textual relation, and the ML manager to re-train the neural model with the detected amendment and identified component.

3. The computer system of claim 1, wherein the annotation manager subjecting the first document to the first semantic annotation further comprises the annotation manager to convert input data from one of the first document and the second document into a javascript object notation (JSON) format, including all necessary data and metadata to represent input content to the neural model.

4. The computer system of claim 3, further comprising the document manager to identify all content and positional changes between the second un-annotated document and the second enriched document, including compare the second semantic annotations with the JSON format of the second document.

5. The computer system of claim 4, further comprising the document manager to convert the second document to the original format and overlay the second semantic annotations to the second un-annotated document in the original format.

6. The computer system of claim 1, wherein building the neural model, includes the ML manager to build one or more entity neural models, one or more relation neural models, and one or more textual annotation models.

7. A computer program product for maintaining knowledge resources, the computer program product comprising a computer readable storage medium having program code embodied therewith, the program code executable by a processor to:
subject a first document to a first semantic annotation, including identify one or more entities, relations, and textual annotations of interest;
build a neural model, and training the neural model with the first document, including one or more first semantic annotations of the first document;
apply a second un-annotated document to the built neural model, the neural model producing one or more second semantic annotations;
enrich the second document with produced one or more second semantic annotations, including embed the second document with the produced second semantic annotations, and subject the enriched second document to adjudication; and
responsive to the adjudication, selectively amend the neural model with one or more of the produced second semantic annotations.

8. The computer program product of claim 7, further comprising program code to detect an amendment of one or more of the produced second semantic annotations, including identify a component of the amendment selected from the group consisting of: an entity and a textual relation, and re-train the neural model with the detected amendment and identified component.

9. The computer program product of claim 7, wherein the program code to subject the first document to the first semantic annotation further comprises program code to convert input data from one of the first document and the second document into a javascript object notation (JSON) format, including all necessary data and metadata to represent input content to the neural model.

10. The computer program product of claim 9, further comprising program code to identify all content and positional changes between the second un-annotated document and the second enriched document, including compare the second semantic annotations with the JSON format of the second document.

11. The computer program product of claim 10, further comprising program code to convert the second document to the original format and overlay the second semantic annotations to the second un-annotated document in the original format.

12. The computer program product of claim 7, wherein building the neural model, includes program code to build one or more entity neural models, one or more relation neural models, and one or more textual annotation models.

13. A method comprising:
subjecting a first document to a first semantic annotation, including identifying one or more entities, relations, and textual annotations of interest;
building a neural model, and training the neural model with the first document, including one or more first semantic annotations of the first document;
applying a second un-annotated document to the built neural model, the neural model producing one or more second semantic annotations;
enriching the second document with produced one or more second semantic annotations, including embedding the second document with the produced second semantic annotations, and subjecting the enriched second document to adjudication; and
responsive to the adjudication, selectively amending the neural model with one or more of the produced second semantic annotations.

14. The method of claim 13, detecting an amendment of one or more of the produced second semantic annotations, including identify a component of the amendment selected from the group consisting of: an entity and a textual relation, and re-training the neural model with the detected amendment and identified component.

15. The method of claim 13, wherein subjecting the first document to the first semantic annotation further comprises converting input data from one of the first document and the second document into a javascript object notation (JSON) format, including all necessary data and metadata to represent input content to the neural model.

16. The method of claim 15, further comprising identifying all content and positional changes between the second un-annotated document and the second enriched document, including comparing the second semantic annotations with the JSON format of the second document.

17. The method of claim 16, further comprising converting the second document to the original format and overlaying the second semantic annotations to the second un-annotated document in the original format.

18. The method of claim 13, wherein building the neural model, includes building one or more entity neural models, one or more relation neural models, and one or more textual annotation models.
